(19) United States
(12) Patent Application Publication
(10) Pub. No.: US 2013/0159589 A1
(43) Pub. Date: Jun. 20, 2013

(54) BUS CONTROL DEVICE AND BUS CONTROL METHOD

(71) Applicant: FUJITSU LIMITED, Kawasaki-shi (JP)

(72) Inventor: Kazuyoshi TAKAYAMA, Kawasaki (JP)

(73) Assignee: FUJITSU LIMITED, Kawasaki-shi (JP)

(21) Appl. No.: 13/767,219

(22) Filed: Feb. 14, 2013

Related U.S. Application Data
(63) Continuation of application No. PCT/JP2010/064011, filed on Aug. 19, 2010.

(51) Int. Cl. G06F 13/26; G06F 13/40

(52) U.S. Cl. CPC G06F 13/26; G06F 13/40
USPC 710/307

(57) ABSTRACT

A bus control device includes a storing unit that stores therein a threshold related to bus width of a bus that is a transfer path for data, a comparing unit that compares, when the bus width is reduced, the reduced bus width with the threshold stored in the storing unit, and a selecting unit that selects, on the basis of the result of the comparison performed by the comparing unit, an interrupt operation performed on a processor that performs a process related to a reduction of the bus width.

### CROSS-REFERENCE TO RELATED APPLICATION(S)

This application is a continuation of International Application No. PCT/JP2010/064011, filed on Aug. 19, 2010, the entire contents of which are incorporated herein by reference.

### FIELD

The embodiments discussed herein are related to a bus control device and a bus control method.

### BACKGROUND

There is a conventional bus control system in which, if a failure occurs in a part of a bus, the bus width is reduced by disconnecting the part of the bus in which the failure has occurred and thus the operation of the bus can be continued. For example, with the PCI-Express standard, a reduction of lanes is specified when a failure occurs in a transmission line made up of multiple lanes.

When hardware detects a failure in a bus and reduces the bus width, this bus control system generates an interrupt in a processor and thus notifies software, operating in the processor, that bus width has been reduced. For example, when a Link Bandwidth Notification mechanism reduces the bus width, a PCI-Express generates an interrupt and thus notifies a processor that the bus width has been reduced.

Then, in order to perform an appropriate process in accordance with the reduced bus width, the software that has received the notification reads the reduced bus width from the register in hardware representing the bus status and selects a process on the basis of the read value. The register representing this status of the bus corresponds to, for example, a Negotiated Link Width field in a Link Status Register for a PCI-Express.

In the following, a conventional bus control system will be described with reference to FIG. 9. FIG. 9 is a schematic diagram illustrating a conventional bus control system. As illustrated in FIG. 9, it is assumed that an information processing apparatus 9 includes, for example, a processor 91, a unit A 92, and a unit B 93. If a failure occurs in a bus 94, which connects the unit A 92 and the unit B 93, a bus control unit 921 in the unit A 92 reduces the bus width of the bus 94 and stores the reduced bus width in an effective bus width register 921a that represents the bus status. Then, when an interrupt control unit 922 in the unit A 92 receives a notification signal indicating a reduction of the bus width from the bus control unit 921, an interrupt is generated by sending a notification of the bus reduction to the processor 91.

Furthermore, in the processor 91, when software accepts an interrupt indicating a bus reduction notification from the interrupt control unit 922, the processor 91 reads a value in the effective bus width register 921a in the unit A 92 and performs the appropriate process, such as a process for disconnecting the unit B 93, in accordance with the read value.

With regard to the conventional techniques, see Japanese Laid-open Patent Publication No. 2009-116732, Japanese Laid-open Patent Publication No. 2005-332357, and Japanese Laid-open Patent Publication No. 2009-140246, for example.

However, with the bus control system, there is a problem in that a burden is placed on the software that accepts an interrupt indicating a bus reduction notification. Specifically, because the software needs to read the reduced bus width from the register representing the bus status in the hardware that has detected a failure, a large burden remains until an appropriate process is selected.

In particular, a register representing the bus status is often mounted on a Large Scale Integration (LSI) that is different hardware to the processor in which software is executed. Consequently, it takes time for the software to read the bus width from the register and thus a burden is placed on the software.

Furthermore, before a process is appropriately selected, the priority of processes is not determined. Accordingly, even if the selected process is a low priority process that does not need bus recovery, the software needs to perform, with high priority, a process between the acceptance of an interrupt and the selection of a process, and thus a burden is placed on the software.

### SUMMARY

According to an aspect of an embodiment, a bus control device includes a storing unit that stores therein a threshold related to bus width of a bus that is a transfer path for data, a comparing unit that compares, when the bus width is reduced, the reduced bus width with the threshold stored in the storing unit, and a selecting unit that selects, on the basis of the result of the comparison performed by the comparing unit, an interrupt operation performed on a processor that performs a process related to a reduction of the bus width.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram illustrating the configuration of a bus control device according to a first embodiment;

FIG. 2 is a functional block diagram illustrating the configuration of a server device according to a second embodiment;

FIG. 3 is a flowchart illustrating the flow of a process performed by an interrupt control circuit according to the second embodiment;

FIG. 4 is a flowchart illustrating the flow of a process performed by a CPU according to the second embodiment;

FIG. 5 is a functional block diagram illustrating the configuration of a system according to a third embodiment;

FIG. 6 is a flowchart illustrating the flow of a process performed by an interrupt control circuit according to the third embodiment;

FIG. 7 is a flowchart illustrating the flow of a process performed by a system management device according to the third embodiment;

FIG. 8 is a flowchart illustrating the flow of a process performed by a CPU according to the third embodiment; and

FIG. 9 is a schematic diagram illustrating a conventional bus control system.

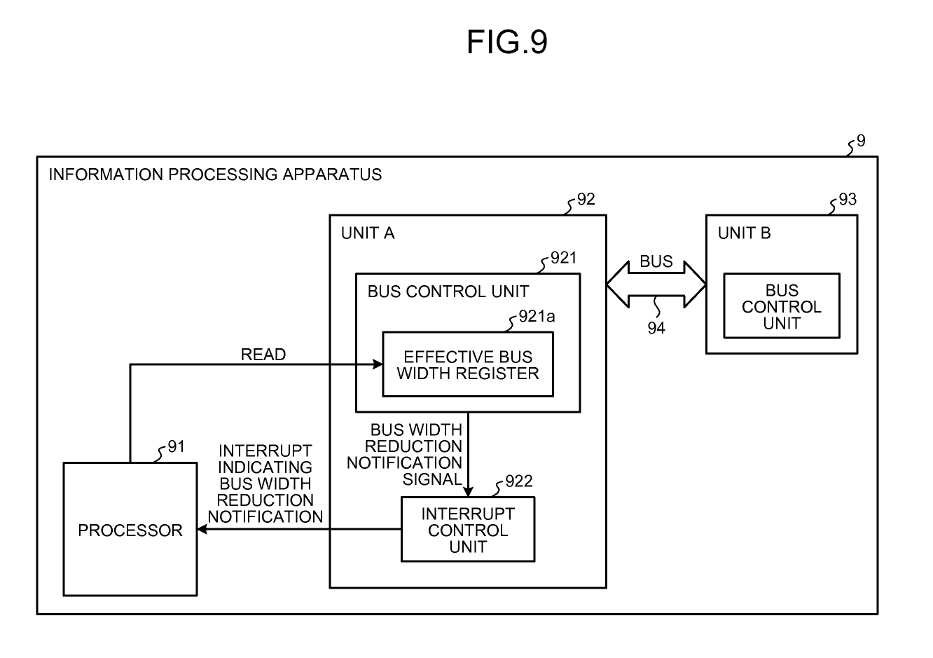

### DESCRIPTION OF EMBODIMENTS

Preferred embodiments of the present invention will be explained with reference to accompanying drawings.

The present invention is not limited to the embodiments.

### [a] First Embodiment

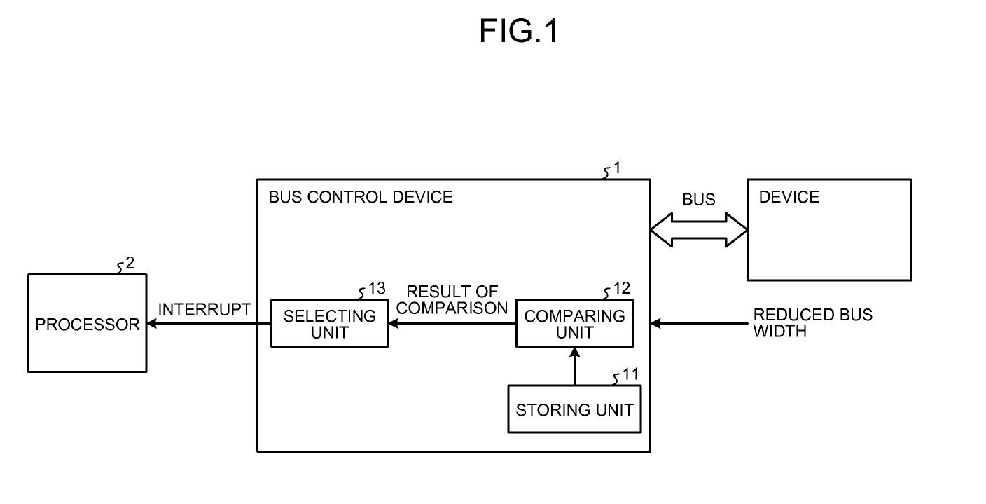

FIG. 1 is a functional block diagram illustrating the configuration of a bus control device 1 according to a first embodiment. As illustrated in FIG. 1, The bus control device 1 includes a storing unit 11, a comparing unit 12, and a selecting unit 13.

The storing unit 11 stores therein a threshold related to the bus width of a bus that is a transfer path for data.

The comparing unit 12 compares, when the bus width is reduced, the reduced bus width with the threshold stored in the storing unit 11.

The selecting unit 13 selects, on the basis of the result of the comparison performed by the comparing unit 12, an interrupt operation performed on a processor 2 that processes bus reduction.

As described above, the bus control device 1 stores therein the threshold related to the bus width of a bus, uses the stored threshold to compare the reduced bus width, and selects, on the basis of the result of the comparison, the interrupt operation performed on the processor. Consequently, because the bus control device 1 generates, in the processor 2, an interrupt on the basis of the selected interrupt operation, it is possible to reduce the processing burden related to a reduction of the bus width of the processor that received the interrupt.

### [b] Second Embodiment

Configuration of a Server Device According to a Second Embodiment

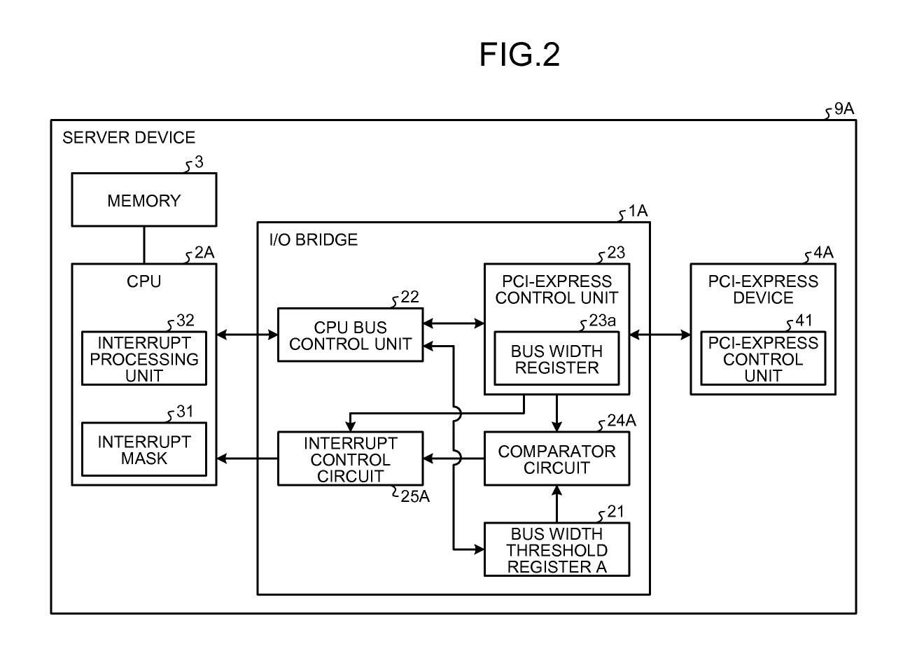

FIG. 2 is a functional block diagram illustrating the configuration of a server device 9A according to a second embodiment. The server device 9A includes an I/O bridge 1A, a CPU 2A, a memory 3, and a PCI-Express device 4A. The I/O bridge 1A is connected to the CPU 2A by a CPU bus. Furthermore, the I/O bridge 1A has a PCI-Express root complex function and is connected to the PCI-Express device 4A by a 4-lane PCI-Express bus. When a failure occurs in a part of the PCI-Express bus, the PCI-Express bus disconnects the part of the lane in which a failure has occurred and reduces the number of lanes. The PCI-Express bus with which the I/O bridge 1A is connected to the PCI-Express device 4A is not limited to 4 lanes. For example, an 8-lane or 16-lane PCI-Express bus may also be used.

The I/O bridge 1A includes a bus width threshold register A 21, a CPU bus control unit 22, a PCI-Express control unit 23, a comparator circuit 24A, and an interrupt control circuit 25A. The CPU 2A is connected to the memory 3, which stores therein a program and various data related to a reduction of the bus width, and executes the program. The CPU 2A includes an interrupt mask 31 and an interrupt processing unit 32. The PCI-Express device 4A includes a PCI-Express control unit 41.

The bus width threshold register A 21 stores therein the threshold related to the bus width of the PCI-Express bus. Specifically, the bus width threshold register A 21 stores therein the number of lanes, as the threshold related to the bus width (hereinafter, simply referred to as the “threshold”), that is satisfactory for the PCI-Express bus to operate. In other words, the bus width threshold register A 21 stores therein, as the threshold, the number of lanes needed to continue the operation performed by the PCI-Express device 4A. The threshold in the bus width threshold register A 21 is stored by the CPU bus control unit 22, which will be described later.

The CPU bus control unit 22 controls the communication with the CPU 2A via the CPU bus. For example, the CPU bus control unit 22 receives a threshold that is previously set by a system designer from the CPU 2A when the system is initialized and stores the threshold in the bus width threshold register A 21. Alternatively, the CPU bus control unit 22 may also receive a threshold from the CPU 2A when the PCI-Express device 4A connected to the PCI-Express bus is initialized and may also store the threshold in the bus width threshold register A 21. Furthermore, thresholds may also be different values for each type of the PCI-Express device 4A.

If a failure has occurred in a part of a PCI-Express bus, the PCI-Express control unit 23 reduces the number of lanes together with the PCI-Express control unit 41 in the PCI-Express device 4A. Furthermore, the PCI-Express control unit 23 includes a bus width register 23a that stores therein the number of lanes that corresponds to the reduced bus width. Specifically, if a failure occurs in a part of a PCI-Express bus, the PCI-Express control unit 23 reduces the bus width of the bus in which a failure has occurred and stores the reduced bus width in the bus width register 23a. Furthermore, the PCI-Express control unit 23 outputs, to the interrupt control circuit 25A, a bus width reduction notification indicating that the bus width has been reduced and outputs the reduced bus width to the comparator circuit 24A. The bus width register 23a corresponds to, for example, a Negotiated Link Width field in a Link Status Register.

When the bus width is reduced, the comparator circuit 24A compares the reduced bus width with the threshold stored in the bus width threshold register A 21 and notifies the interrupt control circuit 25A of the result of the comparison. For example, when the comparator circuit 24A receives the reduced bus width from the PCI-Express control unit 23, the comparator circuit 24A compares the reduced bus width with the threshold stored in the bus width threshold register A 21. The comparator circuit 24A notifies the interrupt control circuit 25A of the result of the comparison indicating whether the reduced bus width is equal to or greater than the threshold.

The interrupt control circuit 25A selects, on the basis of the result of the comparison from the comparator circuit 24A, the interrupt operation performed on the CPU 2A that performs a process for reducing the bus width. The interrupt operation mentioned here includes, for example, an operation performed on the basis of the presence or absence of an interrupt performed on the CPU 2A or an operation performed on the basis of the type of interrupt if the CPU 2A is interrupted. Furthermore, the type of interrupt mentioned here means, for example, an interrupt whose priority is lower or higher than the reference priority.

Specifically, if the result of the comparison indicates that the reduced bus width is equal to or greater than the threshold, the interrupt control circuit 25A determines that the number of lanes is satisfactory for the PCI-Express bus to operate. Then, the interrupt control circuit 25A generates a low priority interrupt in the CPU 2A. In contrast, if the result of the comparison indicates that the reduced bus width is less than the threshold, the interrupt control circuit 25A determines that the number of lanes is not satisfactory for the PCI-Express to operate. Then, the interrupt control circuit 25A generates a high priority interrupt in the CPU 2A.

If, for example, it is assumed that the threshold stored in the bus width threshold register A 21 is “2” and the number of lanes of the PCI-Express bus is reduced from four to two, then in such a case, because the reduced bus width (“2”) is equal to or greater than “2”, i.e., the threshold, the interrupt control circuit 25A determines that the number of lanes is satisfactory for the PCI-Express bus to operate and generates a low priority interrupt in the CPU 2A. In contrast, if it is assumed that the threshold stored in the bus width threshold register A 21 is “2” and the number of lanes of the PCI-Express bus is reduced from four to one, then in such a case, because the reduced bus width (“1”) is less than “2”, i.e., the threshold, the interrupt control circuit 25A determines that the number of lanes is not satisfactory for the PCI-Express bus to operate and generates a high priority interrupt in the CPU 2A.

The interrupt mask 31 controls whether to accept an interrupt. If the interrupt mask 31 accepts the generated interrupt from the interrupt control circuit 25A, the interrupt mask 31 sets, in order to operate the process associated with the type of the accepted interrupt, a program counter in a corresponding address.

The interrupt processing unit 32 executes the process in accordance with the type of the interrupt. Specifically, if the interrupt is a high priority interrupt, the interrupt processing unit 32 executes a stop process on the PCI-Express device 4A and executes a system recovery process that, for example, re-allocates processing to another PCI-Express device. Then, the interrupt processing unit 32 collects detailed log information in order to use it for a failure analysis and stores it in a storage device, such as a hard disk. In contrast, if an interrupt is a low priority interrupt, the interrupt processing unit 32 stores, as log information, information indicating the bus width has been reduced in a storage device, such as a hard disk.

Flow of a Process Performed by the Interrupt Control Circuit According to the Second Embodiment

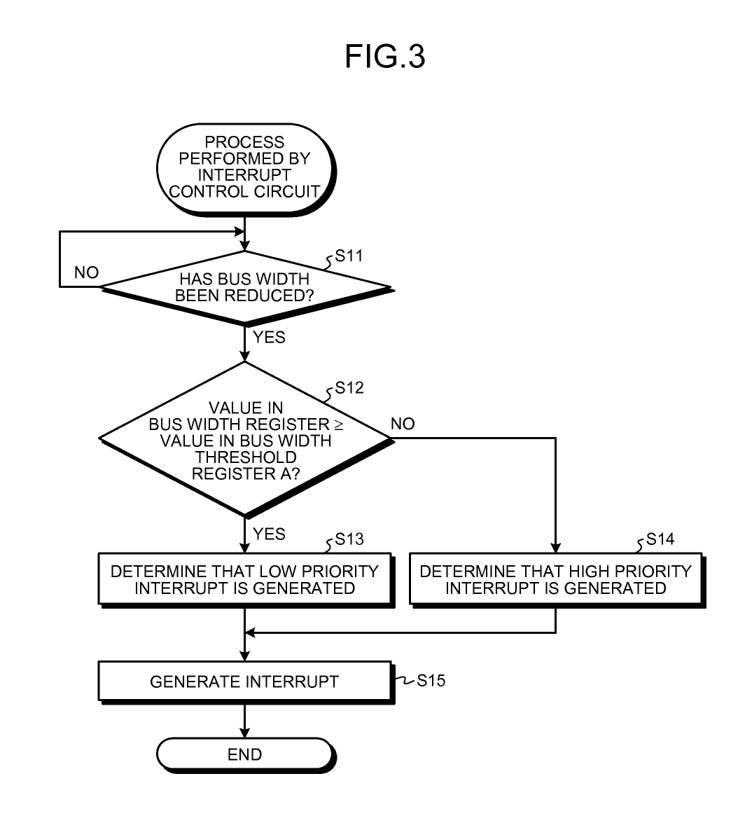

In the following, the flow of a process performed by the interrupt control circuit according to the second embodiment will be described with reference to FIG. 3. FIG. 3 is a flowchart illustrating the flow of a process performed by an interrupt control circuit according to the second embodiment.

First, the interrupt control circuit 25A determines whether the bus width has been reduced (Step S11). Specifically, the interrupt control circuit 25A determines whether a bus width reduction notification has been received from the PCI-Express control unit 23.

If the interrupt control circuit 25A determines that the bus width has not been reduced (No at Step S11), the interrupt control circuit 25A moves to Step S11 to wait for the occurrence of the bus width reduction. In contrast, if the interrupt control circuit 25A determines that the bus width has been reduced (Yes at Step S11), the interrupt control circuit 25A determines whether the value in the bus width register 23a is equal to or greater than that in the bus width threshold register A 21 (Step S12). The value in the bus width register 23a indicates a reduced bus width and the value in the bus width threshold register A 21 indicates the number of lanes that is satisfactory for the PCI-Express bus to operate.

Subsequently, if the interrupt control circuit 25A determines that the value in the bus width register 23a is equal to or greater than that in the bus width threshold register A 21 (Yes at Step S12), the interrupt control circuit 25A determines that the number of lanes is satisfactory for the PCI-Express bus to operate. Then, the interrupt control circuit 25A determines that a low priority interrupt is generated (Step S13) and moves to Step S15.

In contrast, if the interrupt control circuit 25A determines that the value in the bus width register 23a is less than that in the bus width threshold register A 21 (No at Step S12), the interrupt control circuit 25A determines that the number of lanes is not satisfactory for the PCI-Express bus to operate. Then, the interrupt control circuit 25A determines that a high priority interrupt is generated (Step S14).

Then, the interrupt control circuit 25A generates, in the CPU 2A, an interrupt with the determined priority (Step S15).

Flow of a Process Performed by the CPU According to the Second Embodiment

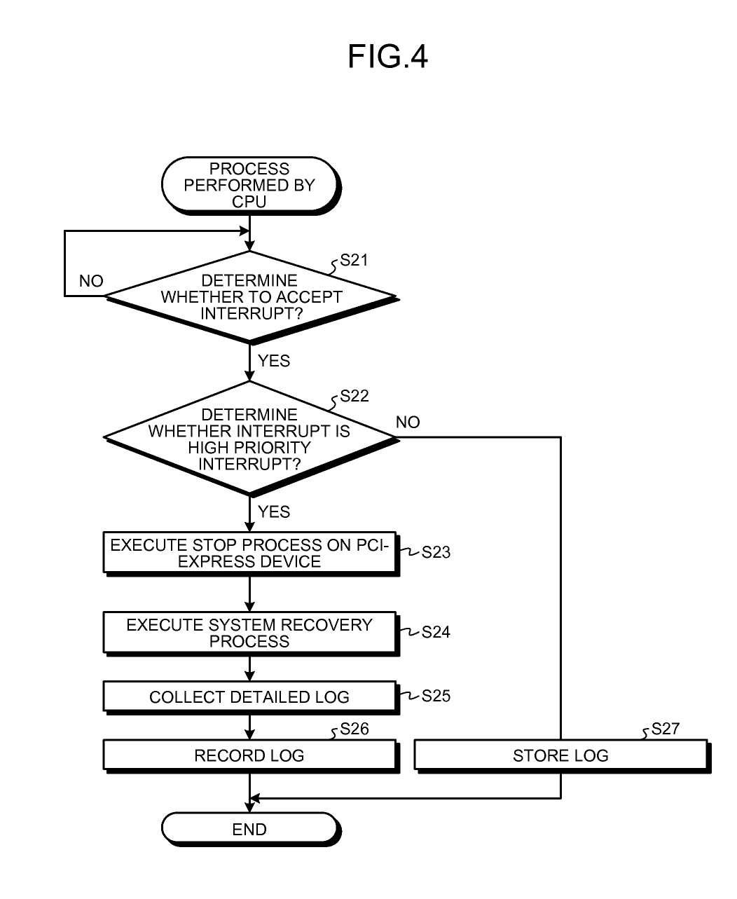

In the following, the flow of a process performed by the CPU according to the second embodiment will be described with reference to FIG. 4. FIG. 4 is a flowchart illustrating the flow of a process performed by a CPU according to the second embodiment.

First, the interrupt mask 31 determines whether to accept an interrupt (Step S21). Then, if the interrupt mask 31 determines not to accept an interrupt (No at Step S21), the interrupt mask 31 moves to Step S21 in order to wait for an interrupt. In contrast, if the interrupt mask 31 determines to accept an interrupt (Yes at Step S21), the interrupt mask 31 accepts the interrupt and sets, in order to operate the process associated with the type of the accepted interrupt, a program counter in the corresponding address.

Subsequently, the interrupt processing unit 32 determines whether the interrupt is a high priority interrupt (Step S22). Then, if the interrupt processing unit 32 determines that the interrupt is a high priority interrupt (Yes Step S22), the interrupt processing unit 32 executes a stop process on the PCI-Express device 4A (Step S23). Then, the interrupt processing unit 32 executes a system recovery process, such as a process that, for example, re-allocates processing to another PCI-Express device (Step S24). Furthermore, the interrupt processing unit 32 collects detailed log information (Step S25) and records the collected log information in a storage device, such as a hard disk (Step S26).

In contrast, if the interrupt processing unit 32 determines that the interrupt is not a high priority interrupt (No at Step S22), the interrupt processing unit 32 stores, in a storage device as log information, information indicating that the bus width has been reduced (Step S27).

### Advantage of the Second Embodiment

According to the second embodiment, the I/O bridge 1A stores the threshold related to the bus width in the bus width threshold register A 21 and compares, when the bus width is reduced, the reduced bus width with the threshold stored in the bus width threshold register A 21. Then, the I/O bridge 1A selects, on the basis of the result of the comparison, the priority of an interrupt performed on the CPU 2A that performs a process related to the reduction of the bus width.

With this configuration, because the I/O bridge 1A generates, in the CPU 2A, an interrupt according to the selected priority, it is possible to reduce the processing burden related to a reduction of the bus width for the CPU 2A that has accepted the interrupt. Specifically, because the I/O bridge 1A compares the reduced bus width with the threshold and generates, in the CPU 2A, an interrupt having a priority that is based on the result of the comparison, it is possible to reduce the processing time, used in the CPU 2A, of a process performed between the acceptance of an interrupt and the selection of a process related to the reduction of the bus width.

Furthermore, because the I/O bridge 1A generates, in the CPU 2A, an interrupt according to the selected priority, it is possible for the CPU 2A that has accepted the interrupt to prevent the accepted interrupt from always being processed with high priority, thus preventing a reduction in system performance. Furthermore, because the I/O bridge 1A generates, in the CPU 2A, an interrupt that takes into consideration the priority, the CPU 2A that accepts an interrupt can manage interrupts in accordance with system loads. For example, if a high load is applied to the system, the CPU 2A can accept only a high priority interrupt, whereas if a low load is applied to the system, the CPU 2A can accept a high priority interrupt and a low priority interrupt. Specifically, the I/O bridge 1A can reduce the effect exerted on a task process in a system due to a reduction of a bus generated in the CPU 2A.

Furthermore, according to the second embodiment, when the device connected to the bus is initialized, the bus width threshold register A 21 stores therein a threshold, which is specified for each type of device connected to a bus, in accordance with the type of device. With this configuration, because, when the device connected to the bus is initialized, the bus width threshold register A 21 stores therein a threshold specified for each type of device, it is possible to perform a recovery process with high accuracy in accordance with the type of device.

### [c] Third Embodiment

In the second embodiment, a description has been given of a case in which the I/O bridge 1A according to the second embodiment stores therein a single threshold related to the bus width, compares the stored threshold with the reduced bus width, and selects, on the basis of the result of the comparison, the priority of an interrupt performed on a processor. However, the I/O bridge 1A is not limited thereto. For example, the I/O bridge 1A may also store therein multiple thresholds related to the bus width, compare the stored multiple thresholds with the reduced bus width, and select, on the basis of the result of the comparison, whether to interrupt a processor or the priority of an interrupt.

Accordingly, in a third embodiment, a description will be given of a case in which an I/O bridge 1B stores therein multiple thresholds related to the bus width, compares the stored multiple thresholds with the reduced bus width, and selects, on the basis of the result of the comparison, whether to interrupt a processor or the priority of an interrupt.

Configuration of a System According to the Third Embodiment

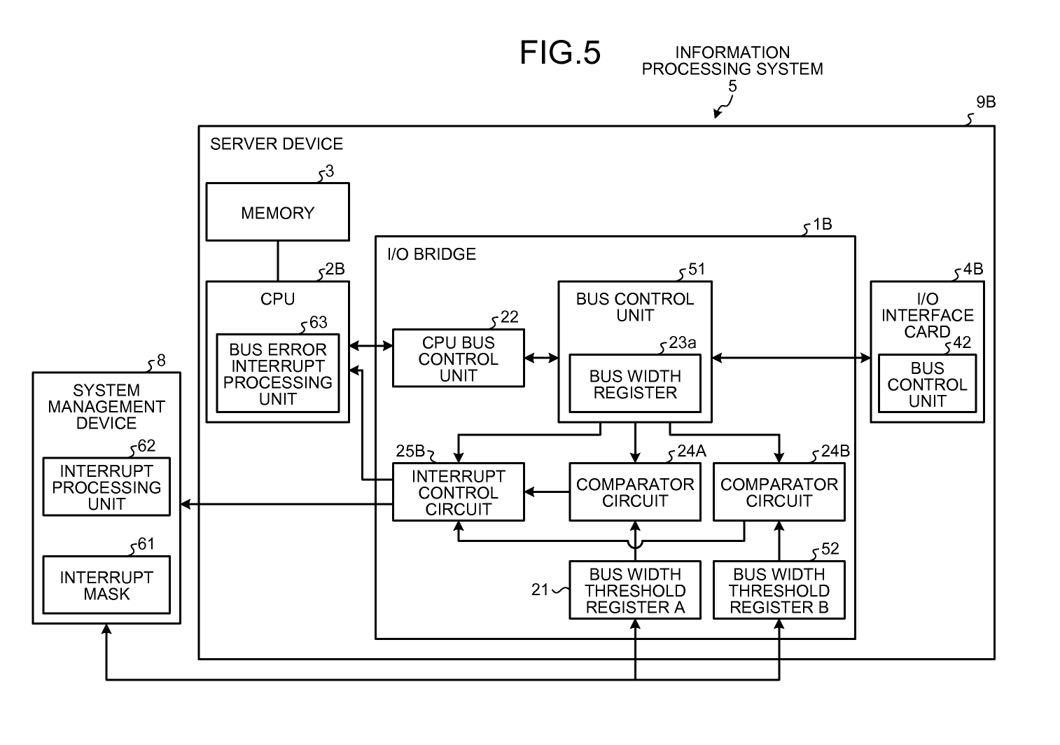

FIG. 5 is a functional block diagram illustrating the configuration of an information processing system 5 that includes a server device 9B according to a third embodiment. The components having the same configuration as those in the server device 9A illustrated in FIG. 2 are assigned the same reference numerals; therefore, descriptions of the configuration and the operation thereof will be omitted. The third embodiment differs from the second embodiment in that a bus width threshold register B 52 and a comparator circuit 24B are added to the I/O bridge 1B. Furthermore, the third embodiment differs from the second embodiment in that the interrupt control circuit 25A and the PCI-Express control unit 23 is replaced by an interrupt control circuit 25B and a bus control unit 51, respectively. Furthermore, the third embodiment differs from the second embodiment in that the PCI-Express device 4A is replaced by an I/O interface card 4B and a system management device 8 is connected to the server device 9B.

The I/O bridge 1B is connected to the I/O interface card 4B by an I/O bus that is a parallel bus with a width of 8 bytes. If a failure occurs in a part of the I/O bus, the bus width of the I/O bus is reduced to 4 bytes, 2 bytes, or 1 byte. Furthermore, the I/O bus with which the I/O bridge 1B connected to the I/O interface card 4B is not limited to an 8-byte width I/O bus.

A CPU 2B is connected to the memory 3 that stores therein a program and various data related to a reduction of a bus and executes the program. The CPU 2B includes a bus error interrupt processing unit 63. The system management device 8 monitors and manages the entire information processing system 5 and includes an interrupt mask 61 and an interrupt processing unit 62.

The bus width threshold register B 52 stores therein the threshold related to the bus width of the I/O bus. Specifically, as the threshold related to the bus width (hereinafter, simply referred to as the “threshold”), the bus width threshold register B 52 stores therein the upper limit of the reduced bus width that is needed for a log record when a failure occurs in an I/O bus. The bus width threshold register A 21 stores therein, as the threshold, the bus width that is satisfactory for the I/O bus to operate. Specifically, the bus width threshold register A 21 stores therein, as the threshold, the minimum bus width needed to continue the operation performed by the I/O interface card 4B. The thresholds in the bus width threshold register A 21 and the bus width threshold register B 52 are stored by the system management device 8, which will be described later.

If a failure has occurred in a part of an I/O bus, the bus control unit 51 reduces the bus width together with a bus control unit 42 in the I/O interface card 4B. Furthermore, the bus control unit 51 reduces the bus width of a bus in which a failure has occurred and stores the reduced bus width in the bus width register 23a. Furthermore, the bus control unit 51 outputs, to the interrupt control circuit 25B, a bus width reduction notification indicating that a reduction of the bus width has occurred, and outputs the reduced bus width to the comparator circuit 24A and the comparator circuit 24B.

When the bus width is reduced, the comparator circuit 24B compares the reduced bus width with the threshold stored in the bus width threshold register B 52 and notifies the interrupt control circuit 25B of the result of the comparison. For example, when the comparator circuit 24B receives the reduced bus width from the bus control unit 51, the comparator circuit 24B compares the reduced bus width with the threshold stored in the bus width threshold register B 52. Then, the comparator circuit 24B notifies the interrupt control circuit 25B of the result of the comparison indicating whether the reduced bus width is equal to or greater than the threshold. The comparator circuit 24A compares the reduced bus width with the threshold stored in the bus width threshold register A 21 and notifies the interrupt control circuit 25B of the result of the comparison indicating whether the reduced bus width is equal to or greater than the threshold.

On the basis of each of the results of the comparison obtained from the comparator circuit 24A and the comparator circuit 24B, the interrupt control circuit 25B selects an interrupt operation with respect to both the CPU 2B and the system management device 8 that perform the process for reducing the bus width. The interrupt operation mentioned here includes, for example, an operation performed on the basis of the presence or absence of an interrupt or an operation performed on the basis of the type of an interrupt if an interrupt occurs. Furthermore, the type of interrupt mentioned here means an interrupt whose priority is lower or higher than the reference priority. Specifically, if the result of the comparison indicates that the reduced bus width is less than the threshold in the bus width threshold register B 52 and is equal to or greater than the threshold in the bus width threshold register A 21, the interrupt control circuit 25B determines that the bus width is satisfactory for an operation that needs a failure record. Then, the interrupt control circuit 25B generates, in the system management device 8, a low priority interrupt.

Furthermore, if the result of the comparison indicates that the reduced bus width is less than the threshold stored in the bus width threshold register A 21, the interrupt control circuit 25B determines that the bus width is not satisfactory for the operation. Then, the interrupt control circuit 25B generates, in the system management device 8, a high priority interrupt and generates, in the CPU 2B, an interrupt indicating a bus error. In contrast, if the result of the comparison indicates that the reduced bus width is equal to or greater than the threshold stored in the bus width threshold register B 52, the interrupt control circuit 25B determines that the bus width is satisfactory for an operation that does not need a failure record. Then, the interrupt control circuit 25B does not generate an interrupt in the system management device 8.

If, for example, it is assumed that the threshold stored in the bus width threshold register B 52 is “4” bytes, that the threshold stored in the bus width threshold register A 21 is “2” bytes, and that the I/O bus is reduced from 8 bytes to 4 bytes, then in such a case, because the reduced bus width (“4”) is equal to or greater than the threshold (“4”) stored in the bus width threshold register B 52, the interrupt control circuit 25B determines that the bus width is satisfactory for an operation that does not need a failure record and thus does not generate an interrupt in the system management device 8.

Furthermore, if it is assumed that the I/O bus is reduced from 8 bytes to 2 bytes, then in such a case, because the reduced bus width (“2”) is less than the threshold (“4”) stored in the bus width threshold register B 52 and is equal to or greater than the threshold (“2”) stored in the bus width threshold register A 21, the interrupt control circuit 25B determines that the bus width is satisfactory for an operation that needs a failure record. Then, the interrupt control circuit 25B generates, in the system management device 8, a low priority interrupt.

Furthermore, if it is assumed that the I/O bus is reduced from 8 bytes to 1 byte, then in such a case, because the reduced bus width (“1”) is less than the threshold (“2”) stored in the bus width threshold register A 21, the interrupt control circuit 25B determines that the bus width is not satisfactory for an operation that needs a failure record. Then, the interrupt control circuit 25B generates, in the system management device 8, a high priority interrupt and generates, in the CPU 2B, an interrupt indicating a bus error.

The interrupt mask 61 controls whether an interrupt is accepted. If the interrupt mask 61 accepts the generated interrupt from the interrupt control circuit 25B, the interrupt mask 61 sets, in order to operate the process associated with the type of the accepted interrupt, a program counter in a corresponding address.

The interrupt processing unit 62 executes a process in accordance with the type of interrupt. Specifically, if an interrupt is a high priority interrupt, the interrupt processing unit 62 collects detailed log information in order to use it for a failure analysis and stores it in a storage device, such as a hard disk. In contrast, if an interrupt is a low priority interrupt, the interrupt processing unit 62 stores, as log information in a storage device, such as a hard disk, information indicating that the bus width is reduced.

When the system is initialized, the system management device 8 stores the threshold, which is previously set by a system designer, in the bus width threshold register A 21 and the bus width threshold register B 52 in the I/O bridge 1B via a system control bus.

If the bus error interrupt processing unit 63 accepts the generated interrupt indicating a bus error from the interrupt control circuit 25B, the bus error interrupt processing unit 63 executes a stop process on the I/O interface card 4B. Furthermore, the bus error interrupt processing unit 63 executes a system recovery process that, for example, switches the I/O access route to another interface circuit.

Flow of a process performed by the interrupt control circuit according to the third embodiment

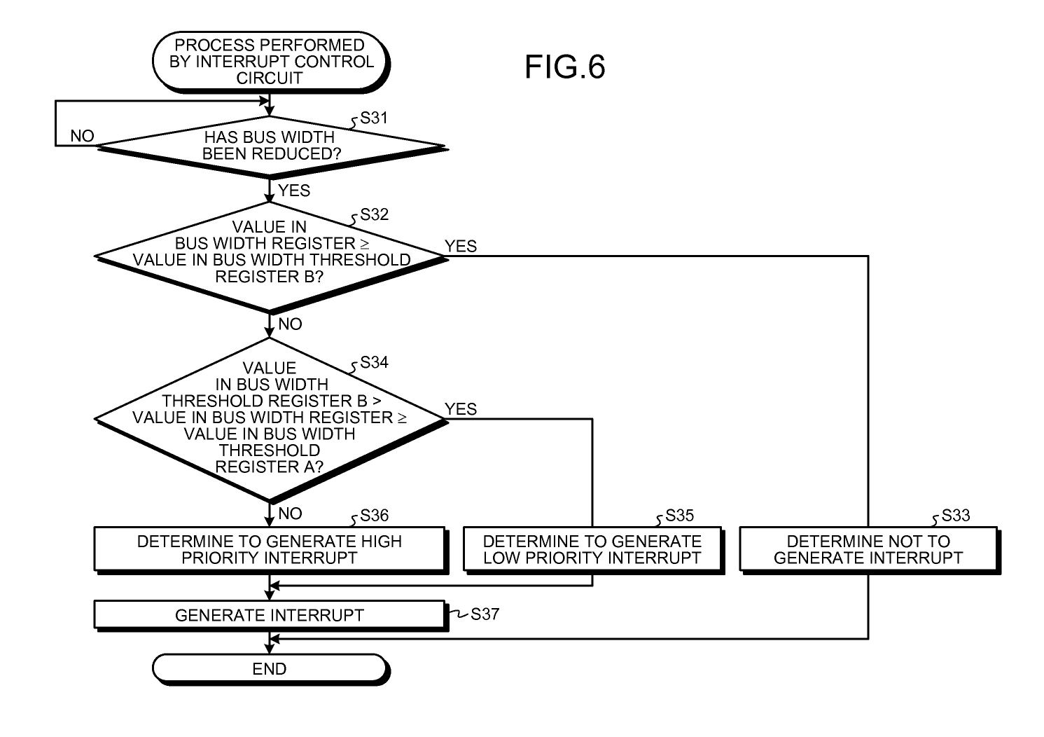

In the following, the flow of a process performed by the interrupt control circuit according to the third embodiment will be described with reference to FIG. 6. FIG. 6 is a flowchart illustrating the flow of a process performed by an interrupt control circuit according to the third embodiment.

First, the interrupt control circuit 25B determines whether the bus width has been reduced (Step S31). Specifically, the interrupt control circuit 25B determines whether a bus width reduction notification has been received from the bus control unit 51.

If the interrupt control circuit 25B determines that the bus width has not been reduced (No at Step S31), the interrupt control circuit 25B moves to Step S31 in order to wait for a reduction in the bus width. In contrast, if the interrupt control circuit 25B determines that the bus width has been reduced (Yes at Step S31), the interrupt control circuit 25B determines whether the value in the bus width register 23a is equal to or greater than that in the bus width threshold register B 52 (Step S32). The value in the bus width register 23a indicates the reduced bus width. Furthermore, the value in the bus width threshold register B 52 indicates the upper limit of the reduced bus width that is needed for a log record when a failure occurs in an I/O bus.

Then, if the value in the bus width register 23a is equal to or greater than that in the bus width threshold register B 52 (Yes at Step S32), the interrupt control circuit 25B determines that the bus width is satisfactory for an operation that does not need a failure record. Then, the interrupt control circuit 25B determines not to generate an interrupt (Step S33) and ends the process.

In contrast, if the value in the bus width register 23a is less than that in the bus width threshold register B 52 (No at Step S32), the interrupt control circuit 25B determines whether the value in the bus width register 23a is equal to or greater than that in the bus width threshold register A 21 (Step S34). The value in the bus width threshold register A 21 indicates the bus width satisfactory for the I/O bus to operate.

If the value in the bus width register 23a is equal to or greater than that in the bus width threshold register A 21 (Yes at Step S34), the interrupt control circuit 25B determines that the bus width is satisfactory for an operation that needs a failure record. Then, the interrupt control circuit 25B determines to generate a low priority interrupt (Step S35) and moves to Step S37.

In contrast, if the value in the bus width register 23a is less than that in the bus width threshold register A 21 (No at Step S34), the interrupt control circuit 25B determines that the bus width is not satisfactory for an operation. Then, the interrupt control circuit 25B determines to generate a high priority interrupt (Step S36) and moves to Step S37.

Subsequently, the interrupt control circuit 25B generates, in the system management device 8, an interrupt according to the priority of the determined interrupt (Step S37). At this point, if the interrupt control circuit 25B generates, in the system management device 8, a high priority interrupt, the interrupt control circuit 25B generates, in the CPU 2B, an interrupt indicating a bus error.

Flow of a process performed by the system management device according to the third embodiment

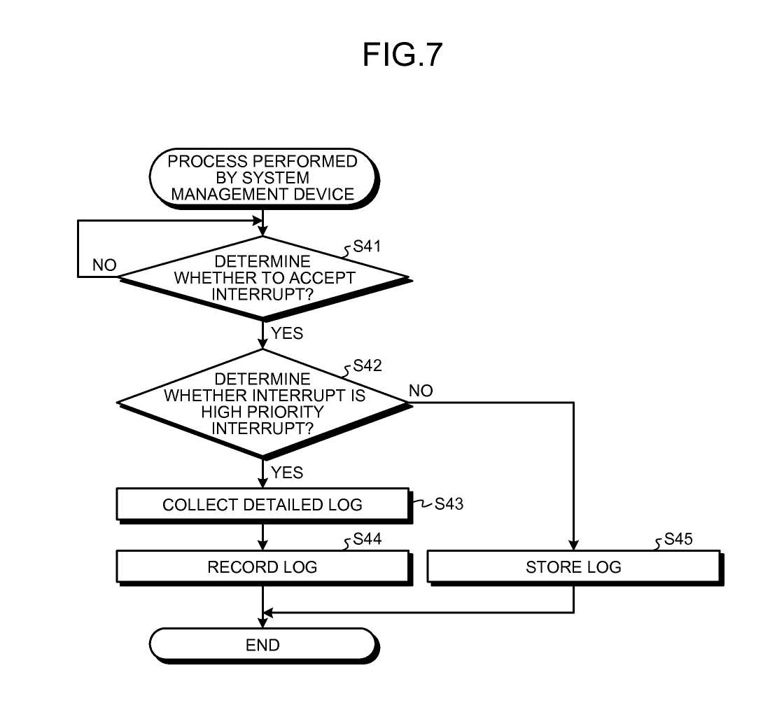

In the following, the flow of a process performed by the system management device according to the third embodiment will be described with reference to FIG. 7. FIG. 7 is a flowchart illustrating the flow of a process performed by a system management device according to the third embodiment.

First, the interrupt mask 61 determines whether to accept an interrupt (Step S41). If the interrupt mask 61 determines not to accept the interrupt (No at Step S41), the interrupt mask 61 moves to Step S41 in order to wait for an interrupt. In contrast, if the interrupt mask 61 determines to accept the interrupt (Yes at Step S41), the interrupt mask 61 accepts the interrupt and sets, in order to operate a process in accordance with the accepted interrupt, a program counter in a corresponding address.

Then, the interrupt processing unit 62 determines whether the interrupt is a high priority interrupt (Step S42). If the interrupt processing unit 62 determines that the interrupt is a high priority interrupt (Yes at Step S42), the interrupt processing unit 62 collects detailed log information (Step S43) and records the collected log information in a storage device, such as a hard disk (Step S44).

In contrast, if the interrupt processing unit 62 determines that the interrupt is not a high priority interrupt (No at Step S42), the interrupt processing unit 62 stores, in a storage device as log information, information indicating the bus width has been reduced (Step S45).

Flow of a Process Performed by the CPU According To the Third Embodiment

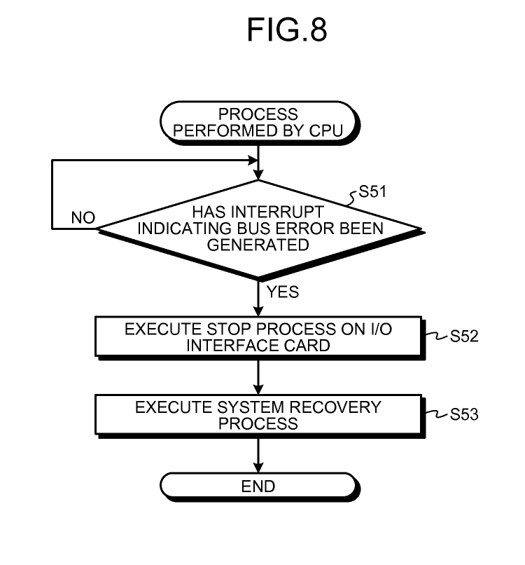

In the following, the flow of a process performed by the CPU according to the third embodiment will be described with reference to FIG. 8. FIG. 8 is a flowchart illustrating the flow of a process performed by a CPU according to the third embodiment.

First, the bus error interrupt processing unit 63 determines whether an interrupt indicating a bus error has been generated (Step S51). If the bus error interrupt processing unit 63 determines that an interrupt indicating a bus error has not been generated (No at Step S51), the bus error interrupt processing unit 63 moves to Step S51 in order to wait for an interrupt indicating a bus error. In contrast, if the bus error interrupt processing unit 63 determines that an interrupt indicating a bus error has been generated (Yes at Step S51), the bus error interrupt processing unit 63 sets, in order to operate a process in accordance with the interrupt indicating the bus error, a program counter in the corresponding address.

Then, the bus error interrupt processing unit 63 executes a stop process on the I/O interface card 4B (Step S52). Then, the bus error interrupt processing unit 63 executes a system recovery process that switches a route to, for example, another interface circuit (Step S53).

### Advantage of the Third Embodiment

According to the third embodiment, on the basis of the result of the comparison performed by the comparator circuit 24A and the comparator circuit 24B, the interrupt control circuit 25B determines whether to generate an interrupt in the system management device 8. With this configuration, if the interrupt control circuit 25B determines, on the basis of the result of the comparison, not to generate an interrupt in the system management device 8, because the interrupt control circuit 25B determines not to generate an interrupt in the system management device 8, it is possible to reduce the processing burden placed on the system management device 8.

Furthermore, according to the third embodiment, the I/O bridge 1B stores, in the bus width threshold register A 21 and the bus width threshold register B 52, the thresholds related to the bus width. Then, if the bus width is reduced, the I/O bridge 1B compares the reduced bus width with both the threshold stored in the bus width threshold register A 21 and the threshold stored in the bus width threshold register B 52. Furthermore, the I/O bridge 1B selects, on the basis of the result of the comparison, whether to interrupt the system management device 8 and the priority of the interrupt. With this configuration, because the I/O bridge 1B stores multiple thresholds related to the bus width, the I/O bridge 1B can perform an interrupt operation by selecting it from among at least three interrupt operations by using multiple thresholds as a boundary. Specifically, the I/O bridge 1B can select either an operation in which an interrupt is not present or an operation in which an interrupt is present, and furthermore, if an interrupt is present, the I/O bridge 1B can select an operation in which the interrupt is set to a low priority or a high priority is set. Consequently, because the system management device 8 can execute an interrupt process in accordance with the selected priority, it is possible to reduce the burden needed to select the process.

Additional

In the second embodiment, a description has been given of a case in which a single I/O bridge 1A is arranged between the CPU 2A and the PCI-Express device 4A; however, the configuration is not limited thereto. For example, it may also be possible to arrange, in series or in parallel, multiple I/O bridges 1A or PCI-Express switches that are arranged between the CPU 2A and the PCI-Express device 4A and are connected using PCI-Express buses. In such a case, the I/O bridge 1A or the PCI-Express switch that detects a reduction of the bus width transmits an interrupt in accordance with the interrupt's priority to the CPU 2A via the I/O bridge 1A or the PCI-Express switch that is arranged between the CPU 2A and the I/O bridge 1A or the PCI-Express switch. Consequently, because the I/O bridge 1A or the PCI-Express switch transmits an interrupt in accordance with the selected interrupt's priority to the CPU 2A, it is possible to reduce the processing burden related to a reduction of the bus width for the CPU 2A that has accepted the interrupt. Similarly, even in the third embodiment, multiple I/O bridges 1B or relay devices connected between the CPU 2B and the I/O interface card 4B by I/O buses may also be arranged in series or in parallel.

Furthermore, in the second embodiment, a description has been given of a case in which the I/O bridge 1A is connected to the PCI-Express device 4A by a PCI-Express bus. However, the I/O bridge 1A may also be connected to an I/O interface card by an I/O bus.

Furthermore, in the third embodiment, a description has been given of a case in which the I/O bridge 1B is connected to the I/O interface card 4B by an I/O bus. However, the I/O bridge 1B may also be connected to a PCI-Express device by a PCI-Express bus.

Furthermore, the server devices 9A and 9B can be implemented by a known information processing apparatus, such as a personal computer or a workstation, having mounted thereon components, such as the above described I/O bridge 1A and the like.

The components of each unit illustrated in the drawings are not always physically configured as illustrated in the drawings. In other words, the specific shape of a separate or integrated device is not limited to the drawings. Specifically, all or part of the device can be configured by functionally or physically separating or integrating any of the units depending on various loads or use conditions. For example, in the third embodiment, the comparator circuit 24A may also be integrated with the comparator circuit 24B as a single unit. In contrast, the interrupt control circuit 25B may also be separated by dividing it into an interrupt selecting unit that determines whether an interrupt is present and an interrupt priority selecting unit that selects the priority of an interrupt if an interrupt is present. Furthermore, the bus width threshold register A 21 and the bus width threshold register B 52 may also be connected as external devices of the server devices 9A and 9B, respectively, via a network.

Of the processes described in the embodiments, the whole or a part of the processes that are mentioned as being automatically performed can be manually performed, or the whole or a part of the processes that are mentioned as being manually performed can be automatically performed using known methods.

According to an aspect of a bus control device disclosed in the present invention, an advantage is provided in that, when the bus width is reduced, it is possible to reduce the burden placed on a processor that accepts an interrupt.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A bus control device comprising:
a storing unit that stores therein a threshold related to bus width of a bus that is a transfer path for data;
a comparing unit that compares, when the bus width is reduced, the reduced bus width with the threshold stored in the storing unit; and
a selecting unit that selects, on the basis of the result of the comparison performed by the comparing unit, an interrupt operation performed on a processor that performs a process related to a reduction of the bus width.

2. The bus control device according to claim 1, wherein the selecting unit selects, on the basis of the result of the comparison performed by the comparing unit, whether to generate an interrupt in the processor.

3. The bus control device according to claim 1, wherein the selecting unit selects, on the basis of the result of the comparison performed by the comparing unit, a priority of an interrupt performed on the processor.

4. The bus control device according to claim 1, wherein
the storing unit stores therein multiple thresholds,
the comparing unit compares the reduced bus width with each of the multiple thresholds stored in the storing unit, and
the selecting unit selects, on the basis of the result of the comparison performed by the comparing unit, the presence or absence of an interrupt performed on the processor and a priority of an interrupt.

5. The bus control device according to claim 1, wherein the storing unit stores therein, in accordance with the type of a device connected to a bus when the device connected to the bus is initialized, the threshold specified for each type of the device connected to the bus.

6. A bus control method, performed by a bus control device when the bus width of a bus that is a transfer path for data is reduced, for generating an interrupt in a processor that performs a process related to a reduction of the bus width, the bus control method comprising:
reading a threshold from a storing unit that stores therein the threshold related to the bus width of the bus and comparing the read threshold with the reduced bus width; and
selecting, on the basis of the result of the comparison performed at the comparing, an interrupt operation performed on the processor.
